(19) United States
(12) Patent Application Publication
(10) Pub. No.: US 2011/0112899 A1
(43) Pub. Date: May 12, 2011

(54) SYSTEMS AND METHODS FOR MANAGING MARKETING PROGRAMS ON MULTIPLE SOCIAL MEDIA SYSTEMS

(75) Inventors: Michael J. Strutton, Villa Rica, GA (US); Slain J. Wilde, New York, NY (US); John C. Maxwell, Atlanta, GA (US); James V. Anderson, Atlanta, GA (US); Bryan S. Pocius, Woodside, NY (US); Adam P. Benjamin, White Plains, NY (US)

(73) Assignee: VITRUE, INC., Atlanta, GA (US)

(21) Appl. No.: 12/859,675

(22) Filed: Aug. 19, 2010

Related U.S. Application Data
(60) Provisional application No. 61/235,277, filed on Aug. 19, 2009.

(51) Int. Cl. G06Q 30/00

(52) U.S. Cl. 705/14.41; 705/14.49

(57) ABSTRACT

System and method for managing marketing programs on multiple social media systems. The method includes the steps of creating a message for one or more social media systems associated with a marketing program. The message is created via a social relationship management (SRM) system that interfaces with the social media systems. The message may be a simple text message or a multimedia message. Next, delivery of the developed message to the social media systems programs is scheduled. The SRM further customizes the message format according to the rules and requirements of the corresponding social networking systems, before publishing the customized message to the social media systems at the scheduled time. The published messages are monitored and appropriate insights are drawn from the monitored messages and their responses by social media system members.

### CROSS-REFERENCE TO RELATED APPLICATION

This application claims benefit under 35 U.S.C. §119(e) of U.S. Provisional Patent Application No. 61/235,277, filed Aug. 19, 2009, and entitled “Social Relationship Manager System and Method”, which is hereby incorporated by reference as if set forth herein in its entirety.

### TECHNICAL FIELD

The present application relates generally to social media systems, and more particularly to methods and systems that support the practice of marketing on social media systems.

### BACKGROUND

The popularity of social media websites or portals, such as Facebook®, Twitter®, LinkedIn®, MySpace®, Buzz®, and others has increased markedly in recent years, compelling marketers and advertisers to analyze the potential of these channels for different types of marketing and advertising. These portals not only provide a platform for individual users to interact, but also present organizations, groups, and communities with potential marketing tools, such as Facebook® pages, or Twitter® handles relating to their products or services, enabling marketers to interact with followers, fans, employees, or members. Marketers can post messages or advertisements on these social media systems as a way to advertise outside of traditional marketing channels. Members, in turn, can respond by clicking on embedded URLs (uniform resource locators), replying to the messages, starting posts based on the messages, or performing other site-specific functions. Further, marketers can embed an organization-specific or campaign-specific URL (webpage address) within the messages, driving users and web traffic to a separate web site.

Even though viral marketing through these social media systems can prove profitable for organizations in terms of additional media coverage, increased click-through rates, greater brand awareness, timely updates, etc., organizations may face difficulties in maintaining and managing more than one marketing campaign or program on an ongoing basis. As referred to herein (and described in greater detail below), a “marketing program” relates to an advertising theme, such as a series of advertisements or messages around a certain time of year (e.g., fall, holiday, summer), certain dates (e.g., Halloween, Christmas, Mother's Day), or certain themes (e.g., back to school, the start of a sporting season). Further, marketing programs may relate generally to a specific marketer, product, or group of products offered by a particular marketer. For example, large corporations with hundreds of different product lines and operations spread worldwide may create separate marketing programs on multiple social media systems for each product line or locality, amounting to thousands of marketing programs. For these corporations, the task of updating and managing these marketing programs with new advertising content on a regular basis can become colossal. Individually updating marketing programs may require efforts from a large number of people. Further, most social networking systems set their own message formats, rules, and instructions, and use their own technology protocols. This makes it not only difficult but a practical impossibility for marketers to remember the rules associated with the programs and to format the messages accordingly. Additionally, the fact that marketing data, metrics, and other data are on multiple platforms makes analysis cumbersome and difficult. Particularly, marketers may find it practically impossible to analyze the success or acceptance of a particular message, or to compare one message or marketing program with another. Currently, no existing service effectively assists marketers and advertisers in managing the marketing programs spread over multiple social media systems.

Therefore, a long-felt but unresolved need exists for a system or method that manages multiple marketing programs on multiple social networking systems. There remains a further need for a system or method that is simple to implement, does not require extensive data analysis, and can be easily configured according to the user's preferences to manage any number of marketing programs.

### BRIEF SUMMARY

Briefly described, and according to one embodiment, the present disclosure describes a computer-implemented method for managing one or more marketing programs present on multiple social networking systems. Initially, the method develops a message for at least one marketing program. The message may comprise a text string, multimedia message, or custom file (such as a .swf file that will render on more than one social media platform). Next, delivery of the developed message to the destination marketing programs is scheduled. The method further customizes the message format according to the corresponding social networking systems, before publishing the customized message on the marketing programs at the scheduled time.

Another embodiment of the present disclosure presents a system for managing one or more marketing programs on multiple social media systems. The system includes a user interface that allows one or more developers to develop messages for at least one destination marketing program, and displays system outputs. A scheduler plans message delivery to the destination marketing programs, and a formatter customizes the message format according to the corresponding social media system. The system further includes a publisher for publishing the message on the marketing program at the scheduled time and a database for storing marketing programs, messages published on the marketing programs, message delivery schedules, and message formats acceptable in different social media systems.

Certain embodiments of the disclosure may offer various technical advantages. For example, certain embodiments may allow marketers or advertisers to maximize click-through rates on the marketing programs by generating interactive and visually stimulating messages from a single platform. Further, other embodiments of the system permit simultaneous or scheduled delivery of one message to multiple marketing programs on one social media system or multiple marketing programs on multiple social media systems. Further, other embodiments of the system may analyze insights from different marketing programs to determine the quality of messages, success of posts, and potential improvements in message content to maximize responses.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment. The drawings are illustrative in nature and are not necessarily drawn to scale.

FIG. 1 is a block diagram illustrating an exemplary environment where embodiments of the present invention are implemented.

FIG. 2 is a block diagram illustrating an exemplary social relationship manager.

FIG. 3 illustrates an exemplary marketing program information database schema.

FIG. 4 is a flowchart illustrating an exemplary method for managing marketing programs on multiple social media systems.

FIG. 5 illustrates an exemplary login screen.

FIG. 6 illustrates an exemplary marketing program addition screen.

FIG. 7 illustrates an exemplary message creation screenshot.

FIG. 8 illustrates an exemplary message scheduler screen.

FIG. 9 is a flowchart illustrating an exemplary method for creating a message.

FIG. 10 illustrates an exemplary URL caption screen.

FIG. 11 illustrates an exemplary media selection screen.

FIG. 12 illustrates an exemplary destination marketing program selection screen.

FIG. 13 is a flowchart illustrating an exemplary method for customizing messages according to a destination social media system.

FIG. 14 is a flowchart illustrating an exemplary method for analyzing insights corresponding to published messages.

FIG. 15 illustrates an exemplary word list screen.

FIG. 16 illustrates an exemplary moderation screen.

FIG. 17 illustrates an exemplary moderated message screen.

FIG. 18 illustrates an exemplary SRM home page screen.

### DETAILED DESCRIPTION

For promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. Limitations of scope should be determined in accordance with and as expressed in the claims.

### Overview

Embodiments of the present disclosure generally relate to aspects of an electronic (e.g., Internet-accessible) system such as a social relationship management system (“SRM” system or “SRMS” or “social relationship manager system” or “manager”) that allows marketers to manage their social media presence by assisting the marketers or advertisers to create, manage, and distribute messages or advertisements associated with one or more marketing programs present on multiple social media systems efficiently from a single user interface. As mentioned previously, a “marketing program” corresponds to a series or grouping of advertisements or messages relating to a particular marketer, product, locality in which a product is offered, etc. Ads or messages associated with a given marketing program may span across many different social media systems, or be directed only to one such system. For example, a large corporation like Sony®, producing hundreds of different products, may develop separate Facebook® pages for each product. Moreover, marketing managers/developers may create different Facebook® corporate pages for each country in which Sony® operates. Similarly, Sony® may have multiple such Buzz® and Twitter® handles. When one considers combinations and permutations of products, locations, and social media, the result can literally be tens of thousands of messages and posts. Managing these messages or posts on a daily basis presents a gargantuan task. The social relationship manager disclosed here simplifies this task by acting as a conduit to enable marketers to interact either directly or indirectly with the marketers' social media systems. Specifically, content developers associated with the marketers can create multiple messages, schedule message delivery, and publish these messages either immediately, or at scheduled times on the social media systems of their associated marketer.

Each social media system has particular standards, rules, and messaging policies, which must be met to operate on that system. For example, some systems may impose a character limit on message text, while other systems may not allow multimedia messages. As used herein, the term “messages” refers to postings, advertisements, or other content published on a social media system. To ensure message compliance with the social media system, an embodiment of the social relationship manager customizes messages for each destination system according to predefined rules. If a destination system does not allow multimedia messages, for example, the manager may not allow a developer to attach media. Alternatively, the manager may simply remove an embedded image or video from a multimedia message before publishing it on the social media system. In order to make formatting decisions, the manager maintains a list of standards and rules pertaining to the social media systems, and compares the message to these standards before publishing the messages. The standards may be updated periodically, if required.

Alternatively, for example, if a certain social media system does not support multimedia messages, the manager may create a separate page with the complete message, and post a text message on the social media system with a link to the complete page. Any user may subsequently select the embedded URL to view the complete multimedia message. In this way, embodiments of the manager allow marketers to build multimedia messages for social media platforms that do not support these messages.

### Exemplary Environment

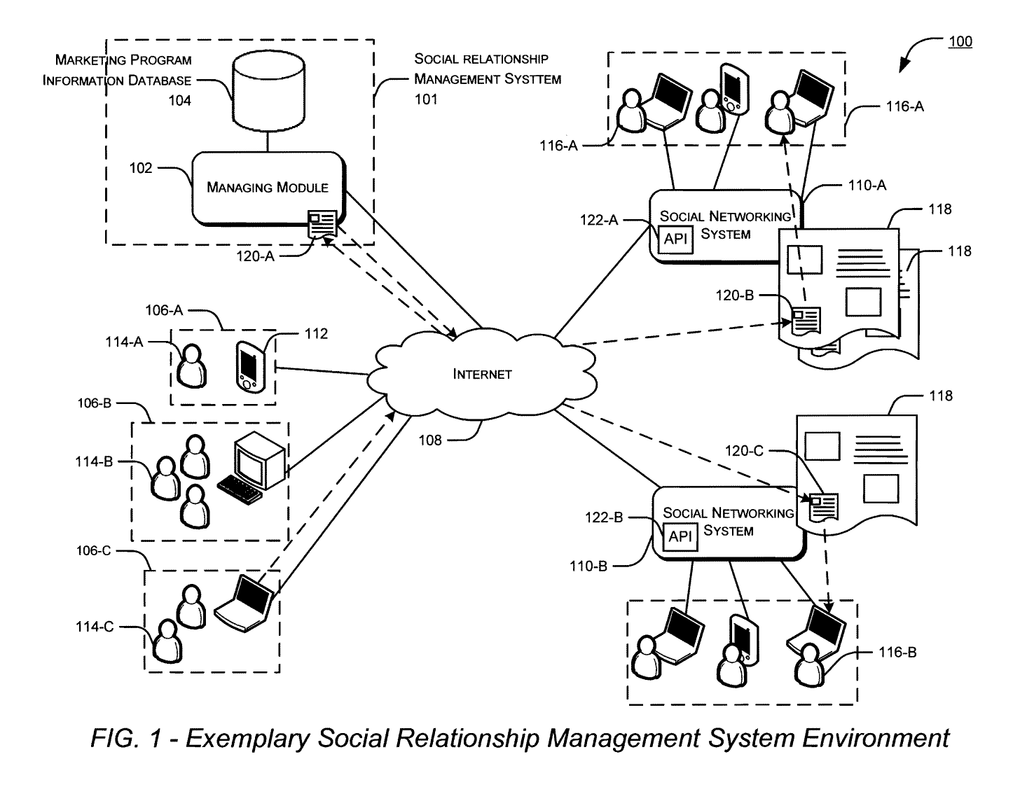

FIG. 1 illustrates an exemplary environment 100 where embodiments of a social relationship manager may operate. The environment 100 includes a social relationship manager (SRM) 101 including a managing module 102 coupled with a database, such as a marketing program information database 104. Clients 106 represented here by individual clients 106-A, 106-B, and 106-C, may access the SRM 101 through a network 108, such as the Internet to publish messages on the social media systems 110. As referred to herein, a “client” represents a marketer, such as a large company, that wishes to utilize the SRM to manage content on its social media systems. The clients 106 interact with the SRM 101 using one or more computing devices 112 (such as cell phones, PDAs, desktops, laptops, tablets, and notebooks). Developers 114, present on the computing devices 112, can develop messages for one or more marketing programs. As referred to herein, a “developer” represents an individual associated with a client that has access privileges to create advertising content of post to the client's social media system accounts. An example of a developer is an employee of the client within the client's marketing department. Moreover, multiple developers 114 may develop messages simultaneously for the same marketing program or for different programs.

FIG. 1 illustrates one developer 114-A associated with client 106-A, three developers 114-B associated with client 106-B, and two developers 114-C associated with client 106-C. It will be understood that different number of developers 114 are depicted in this figure merely to indicate that the SRM 101 may support one or more developers 114 for a single marketing program or client 106. Moreover, it will be understood that in actual situations the number of developers 114 (e.g., hundreds of developers) associated with a particular client 106 may vary considerably from time to time depending on a number of factors such as organization strength, number of active marketing programs, publishing patterns, and other such factors.

The SRM 101 may be connected to social media systems 110 through the network 108. Moreover, members of the social media systems (such as users 116) can access their respective system 110 through the network 108. As referred to herein, a “member” of a social media system is an end user of the system. Thus, the messages and content created by clients and developers will be generally targeted to social media system members.

As shown in FIG. 1, each social media system 110 includes an application programming interface (“API”) 122 that enables embodiments of the present SRM system to interact seamlessly with the social media system. As is understood in the art, an API is an interface that enables the software systems of the social media systems to interact with the software systems of the SRM system. In this way, developers of clients can interact with the SRM system to create advertising content, messages, etc., schedule message delivery amongst many social media systems, and perform other functions without ever directly accessing a social media system. This enables more efficient and centralized management of a plurality of messages across many social media systems. This also enables various contributors with different access levels to coordinate and contribute content to a marketing program based on predetermined settings and rules not necessarily available directly through the social media systems' conventional interface.

In a conventional situation, developers 114 access the social media systems 110 and publish messages/posts relevant to marketing programs on the social media systems. A message may typically include content, such as text, images, video, and the like. Users 116, may reply to the messages, post comments, send messages back to the developer, share messages with other users, etc. The overall purpose of the posts and corresponding user interaction is to create user interest in the marketer's goods or services—similar to traditional advertising. Embodiments of the present invention, however, obviate the need to access marketing programs individually to publish messages. Again, a client is able to manage many different marketing programs, messages associated with those programs, etc., across many different social media systems, or different pages/handles within those systems, all from one convenient user portal. Developers 114 gain access to the SRM 101 through which they can post multiple messages to multiple programs or multiple social media systems 110 at scheduled times or simultaneously. This feature will be illustrated with an example in the following sections.

Developers 114-C for Acme Coffee, a fictitious example company, create one or more marketing programs with one or more corresponding social media pages 118 on the social media systems 110. One social media system, such as system 110-A might carry Acme Coffee's corporate marketing program and two regional marketing programs. Similarly, another corporate marketing program may be active on social media system 110-B. Acme Coffee may want to publish a multimedia message relating to its marketing programs 118 on its corresponding social media system accounts. To do so, the developers 114-C login to the SRM 101 and follow an interactive user interface to create a multimedia message, such as message 120-A. The SRM 101 prompts the developers 114 to either schedule message delivery or publish immediately. The developers 114 may decide to immediately publish on system 110-A, and schedule delivery to the marketing program 118 on system 110-C after two hours (or two days, or three months, etc.). Aspects of the scheduling component of the present system are discussed in greater detail below.

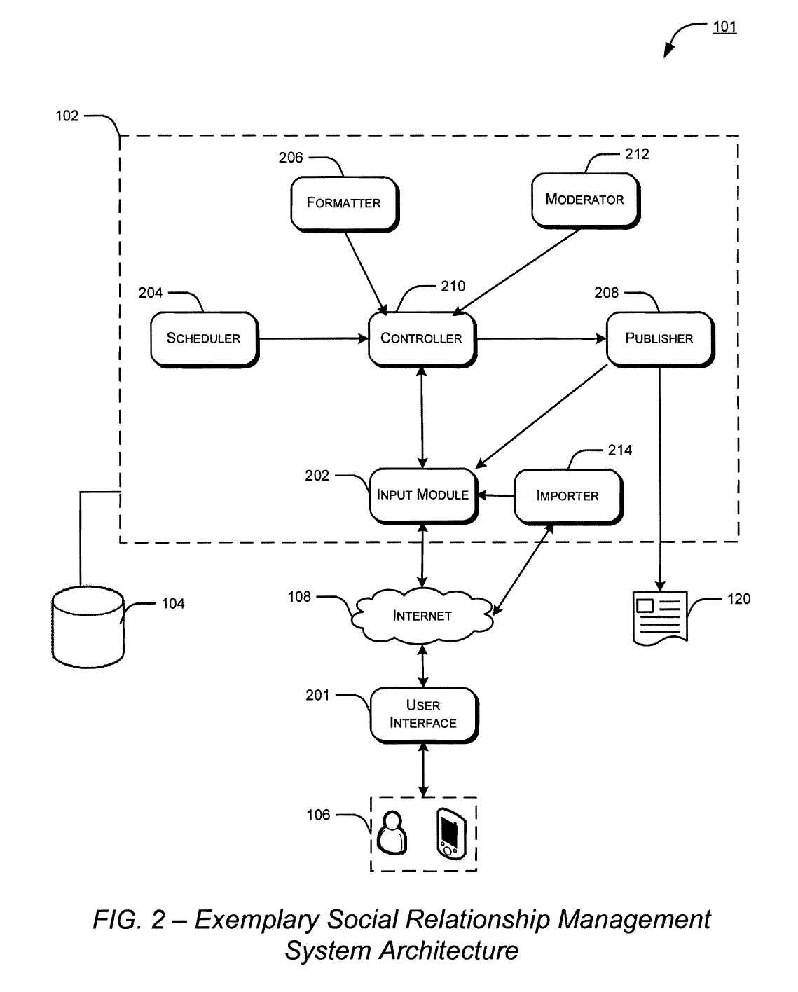

The SRM 101, before delivery, formats the message 120-A according to the destination social media system. For example, the example system shown in FIG. 1 is utilized to create two formatted message copies—one message 120-B compliant with system 110-A and another message 120-C compliant with system 110-B. Subsequently, the SRM 101 saves the formatted messages and delivers message 120-B associated with its respective marketing program(s) on the system 110-A immediately and message 120-C to the system 110-B after the stipulated time. The SRM 101 may notify developers 114 whenever the message 120 is published, or at some time prior to publishing. Moreover, whenever users 116 access the social media system 110, they may be informed of Acme Coffee's publication and can respond to the message, view special offers or coupons, access Acme Coffee's separate corporate web site via a URL, view related multimedia content, etc. The SRM 101 tracks these responses for analysis. These and other features of the SRM 101 will be described in detail with reference to FIGS. 2-10.

### Exemplary System

FIG. 2 illustrates an exemplary architecture for an embodiment of the SRM system 101 for managing one or more marketing programs 118 present on multiple social media systems 110 according to embodiments of the present disclosure. As shown, the SRM 101 includes the managing module 102, the marketing program information database 104, and a user interface 201, connected through the Internet 108 to an input module 202 for accepting inputs and displaying system outputs (such as analytics relating to the success of one or more marketing programs and/or individual marketing messages). The managing module 102 further includes a scheduler 204 for scheduling delivery of messages 120, a formatter 206 for customizing message format according to the destination social media system 110, and a publisher 208 for publishing the message on the destination marketing programs 118 at the scheduled time. The managing module 102 may further include a controller 210 that allows collaboration between multiple developers 114, a moderator 212 to maintain the quality standard of published messages and responses to the published messages. For example, the moderator 212 may scan messages for defamatory or abusive language, names of a particular client's (marketer's) competitors, or embedded URLs, and it then flags any problematic messages, or removes them, or otherwise addresses them as dictated by a system user. The managing module 102 further includes an importer 214 for monitoring and importing message responses from the marketing programs 118 in real time. The importer 214 stores the imported responses in the database 104 for further analysis. Apart from these modules, the managing module 102 may include numerous other modules and databases, which will be described in detail in the following sections.

### User Interface and Input Module

The user interface 201 accepts input commands from developers 114, and notifies the developers of system functions related to the input commands back to the developers 114. The interface 201 accepts instructions from developers 114 and forwards the instructions to the input module 202 that further utilizes this information. The user instructions may include prompts to login to the system, or other system management instructions, as desired.

### Scheduler

The scheduler 204 allows developers 114 to schedule message posts or distribute marketing content with short-term or long term marketing programs. By way of example, the scheduler 204 may allow developers 114 to create multiple messages on a single day and schedule message delivery at precise times in the future. In this way, developers 114 can plan strategies and schedule messages for an entire week, month, or year, etc. in advance. The scheduler 204 operates in conjunction with the publisher 208. The developers 114 schedule message delivery, and the scheduler 204 instructs the publisher 208 to publish the message content to the destination marketing programs 118 at the scheduled time.

The scheduler 204 granularity may be configured as desired. For instance, in some cases, the scheduler 204 may allow developers 114 to select the delivery date; in other cases, the scheduler 204 may allow developers 114 to select both date and time. Further, time selection granularity may also vary. For example, the scheduler 204 may allow time selection from one-hour intervals, half-hour intervals, 15-minute intervals, or some other predetermined arbitrary time interval.

Additionally, the scheduler 204 may repeatedly publish the same message over time. Acme coffee, for instance, may distribute free coffee coupons on the first day of every month. Instead of creating a new coupon every month, a standard coupon may be created once, and scheduled for delivery on the first of every month. Alternatively, Acme Coffee may decide to give away 100 free coffees. In this case, a free coffee coupon may be published every day or every week, until 100 users 116 (i.e., members) respond to the coupon.

### Formatter

The formatter 206 ensures that messages adhere to the rules and policies of the destination social media system 110 regarding font size, text type, maximum number of characters allowed, whether multimedia is allowed, and other similar details. Rather than requiring developers 114 to remember such rules, the formatter 206 may allow developers 114 to create a desired message and later check the message for compatibility with the destination media systems. The formatter 206 may subsequently prompt the developer 114 to modify the text according to the rules, automatically modify the text to comply with the rules, or it may automatically insure corrections, as determined by the system.

Alternatively, the formatter 206 may simply not allow developers 114 to create messages that do not comply with destination system rules. If the character length of certain media system 110 is set to 250 characters, for instance, the formatter 206 may prevent the developer 114 from entering text beyond 250 characters. Similarly, if a certain media system 110 does not allow multimedia messages, instead of permitting the developer 114 to attach media and subsequently informing the developer 114 of the media rules, the formatter 206 may not permit the developer 114 to attach media in the first place, by either hiding or deactivating that option. In one embodiment, if one general message is created for distribution to many different social media systems (each with varying format requirements), then the SRM system may format the message according to each systems' requirements, and then prompt the contributor to change or modify the message for each social media system in which the message may be noncompliant.

In addition to rules and requirements mandated by each different social media system, developers 114 or clients may configure rules and thresholds for the different social media systems 110 with which all of the associated developers must comply. The formatter 206 may subsequently assess the messages according to the rules and raise flags, prompt the developer 114 to modify the message, automatically modify the message, or restrict the developers 114 from creating a message that would violate the configured rules.

Further, the formatter 206 may convert any URL that is embedded into a message into a shorter URL. URLs may be shortened for various reasons. For example, for social media systems that impose character limits, adding very long URL links could potentially exhaust valuable message characters. Those skilled in the art will understand that users are more likely to click-through shorter links than longer ones. For these and other reasons, the social relationship manager shortens URLs to a particular format, which redirects the user to the actual URL using a ‘Meta Refresh’ technology. One advantage of using Meta Refresh to redirect the user to the desired URL is that the user first lands on the link created by the social relationship manager before being redirected to the actual URL. This initial landing allows the social relationship manager to track the number of click-throughs to a site even though the destination URL is not associated with the social relationship manager. Through this tracking, the social relationship manager can gain valuable insights about user behavior, message success, and so on.

According to one embodiment of the present system, the formatter 206 saves the original URL and the shortened URL in a lookup table in the database 104. When a user clicks on the shortened link, the user lands on the short link, and after either a short interval or no interval, the user is redirected to the actual URL.

### Publisher

The publisher 208 receives instructions from the scheduler 204 or directly from the formatter 206 to publish the message associated with its selected destination marketing programs 118 on the corresponding social media systems. As will be understood and appreciated, a message need not necessarily be associated with an overarching marketing program—messages may be separately contained for smaller, “one off” type advertisements. For scheduled messages, message details are stored in the database 104. The publisher 208 retrieves the message along with message details such as an associated marketing program, destination social media system(s), and scheduled delivery time from the database 104 before publishing the message. Moreover, if for any reason, the publisher 208 is unable to publish the message to a particular program, the publisher 208 may generate and circulate an error report to a client and/or its developers. Further, the publisher 208 may be configured to retry publication for a predefined number of times at predefined intervals. The publisher 208 may also be configured to deliver publication notifications to the developer's (or client's) email address, cell phone, or some other delivery mechanism, either before or after publication of the message. It will be understood that other notification techniques are contemplated and within the scope of the present disclosure.

### Controller

The controller 210 is utilized to set up collaboration accounts, permitting multiple developers 114 (such as entire marketing team) to collaborate, share, and work together on marketing strategies, campaigns, or even individual messages. For example, in one embodiment, a lead developer associated with a client will control the overall operations of that client's marketing programs, and will correspondingly control access rights and other functions relating to the client's SRM system account. In this circumstance, the lead developer acts as the “client” (e.g., the company) to make decisions regarding the client's marketing efforts on various social media systems. The lead developer with an existing account on the social manager may invite multiple developers 114 to join the team. Upon approval and acceptance of the invitation, new developers 114 may fully participate in development activities. The inviting developer 114 may set access rights for the invited developers 114. For instance, the controller 210 may allow developers 114 to only create; create and edit; or create, edit, and publish, depending on their access rights.

Using the controller 210, team members may set reminders to complete tasks, create marketing calendars, set alerts, edit each other's work, work together on certain messages, or configure notifications for message publication.

### Moderator

Because messages are published on social media platforms that are accessible by the general public (i.e., members of those systems), developers 114 cannot always control the content of responses to a message or ancillary comments/posts on the client's social media sites. Thus, it may be important to screen user responses to filter out undesirable language or content. To accomplish that result, the managing module 102 includes a moderator 212, which screens responses to published message and filters content. For example, the moderator 212 may filter abusive words, competitor names, racist language, sexist terms, links, images, videos, audio and any other content deemed undesirable. The moderator 212 performs this function by comparing each response with a database 104 of prohibited words, specially-identified content items, etc., which are updated at regular intervals. The parsing techniques are known to the art and may be used if desired. If the moderator 212 identifies any message with a prohibited word, the moderator 212 may flag the message and notify the developer 114 for action. Alternatively, the moderator 212 may automatically remove the message from the marketing program 118 and send a notification to the developer 114. The developer 114 may consequently decide whether the message should be permanently deleted or reinstated. The filtered content may include URLs on a “no-show” list, where users placed on a “banned” list of persons identified as posting undesirable content.

In addition to harmful content, the moderator 212 may also scan messages for good content, such as praise of client products, interest in specific products, or service appreciation. These messages may also be flagged. Developers may utilize this information to distribute incentives, or loyalty coupons to such users 116. Moreover, these messages may also be utilized to improve product lines, etc.

### Importer

The importer 214 extracts information from member/user responses to the messages associated with marketing programs 118 on the social media systems to perform various analytic functions, generate metrics, and provide reports. In one embodiment, the importer 214 monitors the marketing pages and extracts any responses to a published message. In one embodiment, the overall goal of the member responses and corresponding analytics is to determine the relative success of various marketing programs and messages, and identify helpful information regarding marketing of the client's products. The importer 214 may also maintain a tracker for counting useful numbers, such as the number of message replies, plays, and the like. This information can serve as inputs to various analytical programs known to those in the art. Further, the actual messages may also be extracted and stored in the database 104 for analysis. Users 116 may present recommendations, suggestions, or interests, and that input will be useful for generating future marketing strategies. Reports, such as interactive charts, and graphs, can be generated on a planned or ad hoc basis.

Moreover, the importer 214 extracts performance information from the marketing programs 118 as a whole or overall, such as the number or fans or followers, as well as new requests and program activity. Based on this information, developers 114 may set alerts for event notification, such as a sudden change in the fan base.

### Database Schema

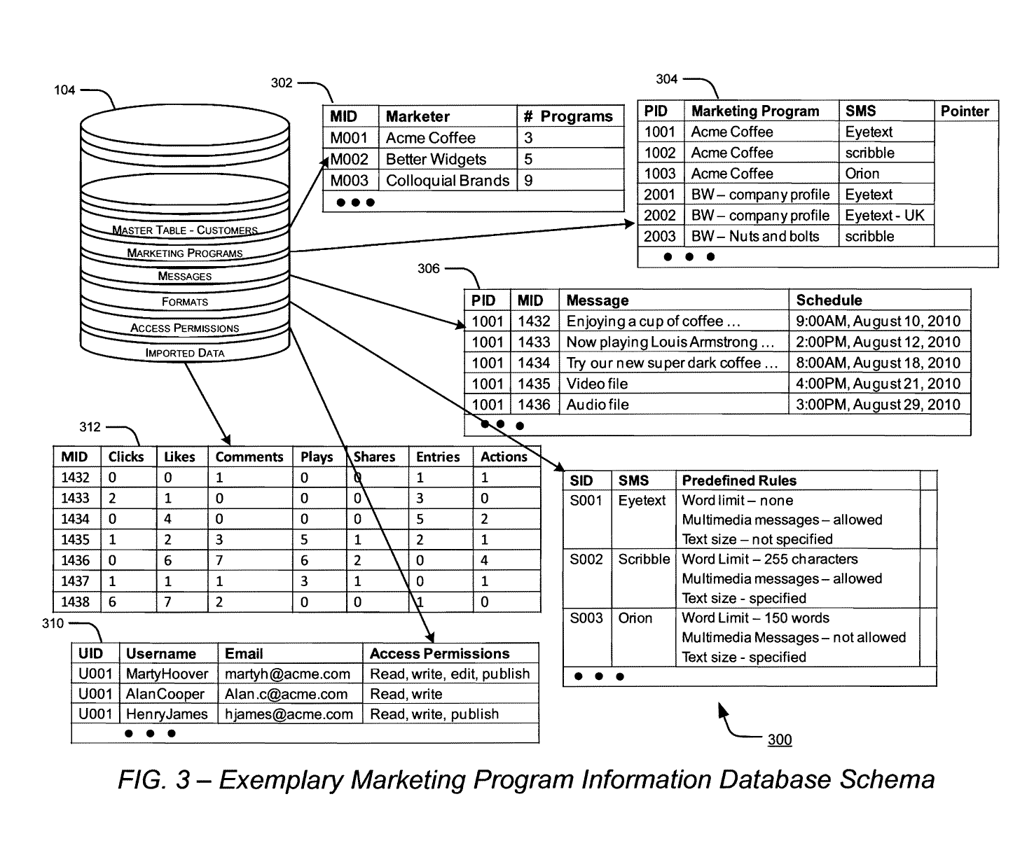

The database 104 stores information about clients, their marketing programs 118 and the associated information, such as published and unpublished messages, and the program metadata, such as the identity of developers 114 and the like. The database also stores message detail information, contributor information, marketing program metrics, and other similar types of information. The database 104 may be refreshed in real-time by the other modules and stale data may be purged as desired. FIG. 3 illustrates an exemplary database schema 300, which may store data in a relational fashion. A typical relational database includes multiple data tables that include pertinent information, each table to which other tables can link. FIG. 3 illustrates some exemplary tables that may be present in the database 104. It will be understood, however, that the number of tables, as well as the data fields and the relations among them may vary depending on the particular embodiment.

The schema 300 includes a master client table 302, which catalogues the active clients 106. This table typically includes unique client IDs, and other useful client details. It will be appreciated that other fields may also be contemplated, within the scope of the present disclosure.

The client table 302 may be associated with one or more marketing program tables, such as marketing program table 304. The database 104 may maintain separate marketing program tables 304 for the clients, or it may store marketing program details in one large table. Here, the schema 300 illustrates a larger table caching details of active marketing programs 118. Some exemplary data fields in this table include unique program IDs, program name, associated social media system, date of activation, date last updated, number of active followers, fan, or members, program description, etc. This table 304 in turn may be associated with a number of message tables 306. The database may maintain separate message tables 306 for each marketing program 118, or may store messages pertaining to a client in one single table. This table 306 stores information relating to individual messages, such as unique message IDs, message titles, message description, message type, creation date and time, publication date and time, embedded URL, author, etc. Other data fields may also be contemplated, such as count of responses, likes, comments, shares, and plays, flags; response messages; or number of revisions.

In addition to these tables, the database 104 may include other tables and data fields that the managing module 102 may utilize in certain embodiments. The database 104, for instance, may include a table, such as format table 308 that stores information about different formatting standard rules and policies adopted by the active social media system 110. Exemplary fields of this table may be social media system ID, social media system name, required format, best practices, etc. The database may incorporate another table that maintains information about the active developers for the marketing programs 118. Typical fields in this table (table 310) may be user ID, first name, last name, username, password, email address, phone numbers, social media profiles, access permissions, and other such developer related fields. Further, the database may include a table that stores analytics and information relating to social media system member interaction with messages and marketing programs such as number of responses to a message, number of likes, shares, click-throughs to linked pages, etc. As will be understood and appreciated, some “responses” to messages will include social media-specific responses, such as the “like” or “share” option offered by Facebook®. A few exemplary fields are illustrated in table 312 in FIG. 3.

It will be understood that the database 104 may maintain numerous other tables not illustrated here. For example, a table that stores alerts, reminders, and triggers for a certain marketing program or client may be present. Similarly, the database 104 may maintain a table for shortened URLs and their corresponding actual/longer URLs. As will be understood and appreciated, the specific tables and corresponding data items shown in FIG. 3 are presented for illustrative purposes only, and other types of data as will occur to one of ordinary skill in the art may be utilized according to various embodiments of the present system.

The database 104 may be updated in real time or on an intermittent basis. As will be further understood, the specific database shown and described is intended to be illustrative only and actual embodiments of the SRM 101 may include various database structures, schemas, etc.

### Exemplary Method(s)

The following sections describe exemplary methods for carrying out one or more embodiments of the present disclosure. The methodology described herein is generally intended to describe various features and functionality of various system components described previously. The order in which the methods are described is not intended to be construed as a limitation and any number of the described method steps can be combined in any order to implement the method, or an alternate method. Additionally, individual steps may be deleted from the methods without departing from the spirit and scope of the subject matter described herein. Furthermore, the method can be implemented in any suitable hardware, software, firmware, or combination thereof.

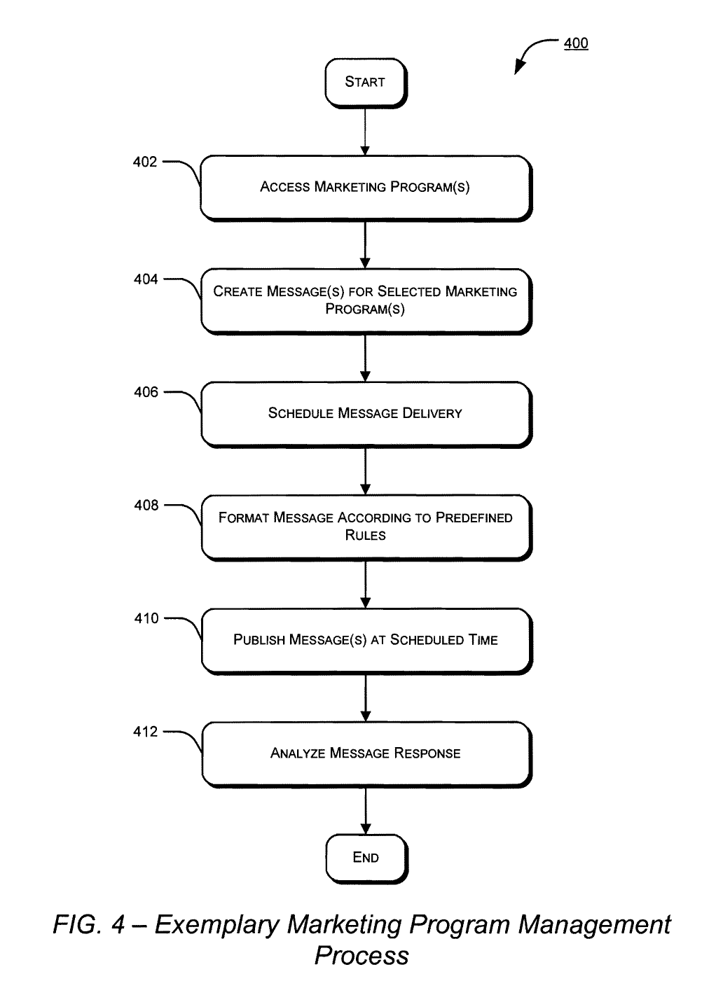

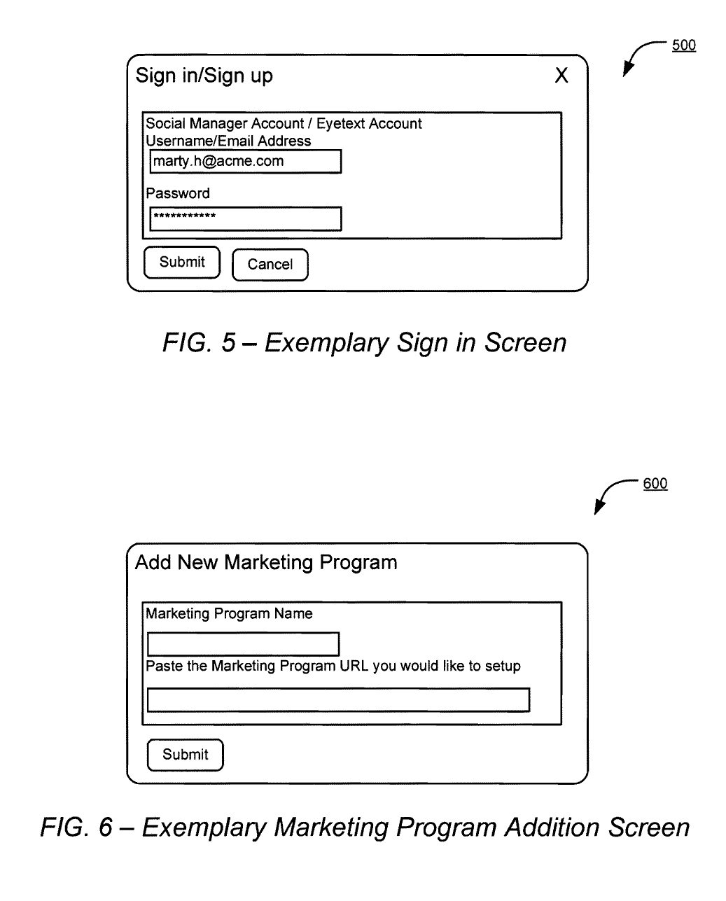

FIG. 4 illustrates an exemplary method 400 for managing one or more marketing programs 118 on multiple social media systems 110. The method begins at step 402 where a client 106 representative (such as a lead marketing developer) accesses one or more marketing programs 118 present on multiple social media systems. A developer 114 may login to the SRM 101 via the user interface 201 by providing identification details. FIG. 5 illustrates an exemplary “login” or user identification screen, which requests developer information. The developer 114 may directly log in using a username (or email address) and a password, or through their social media system credentials.

The marketing programs 118 may already exist, or the client may create these programs as required. According to one embodiment, “creation” of a marketing program simply represents the designation of basic information about a marketing campaign, such as a name, duration, etc. Once the required marketing programs 118 are created, upon authorization, the developer 114 adds or activates the marketing programs 118 on the SRM 101. FIG. 6 illustrates an exemplary marketing program addition screen. Developers may access their marketing programs to authorize access rights for the given program. Authorization and addition of the marketing programs onto the SRM 101 allows the SRM to publish messages in connection with the program, monitor the program, and extract information about the program as required. As will be understood and appreciated, according to one embodiment of the present system, step 402 in FIG. 4 is optional, and an ovearching marketing program need not be created for all message content to be delivered to various social media systems. For example, a marketer/client/developer may wish to simply post a singular message not associated with an overall marketing program to one or more social media systems. In this case, the message is simply created individually, and is not associated with a marketing program.

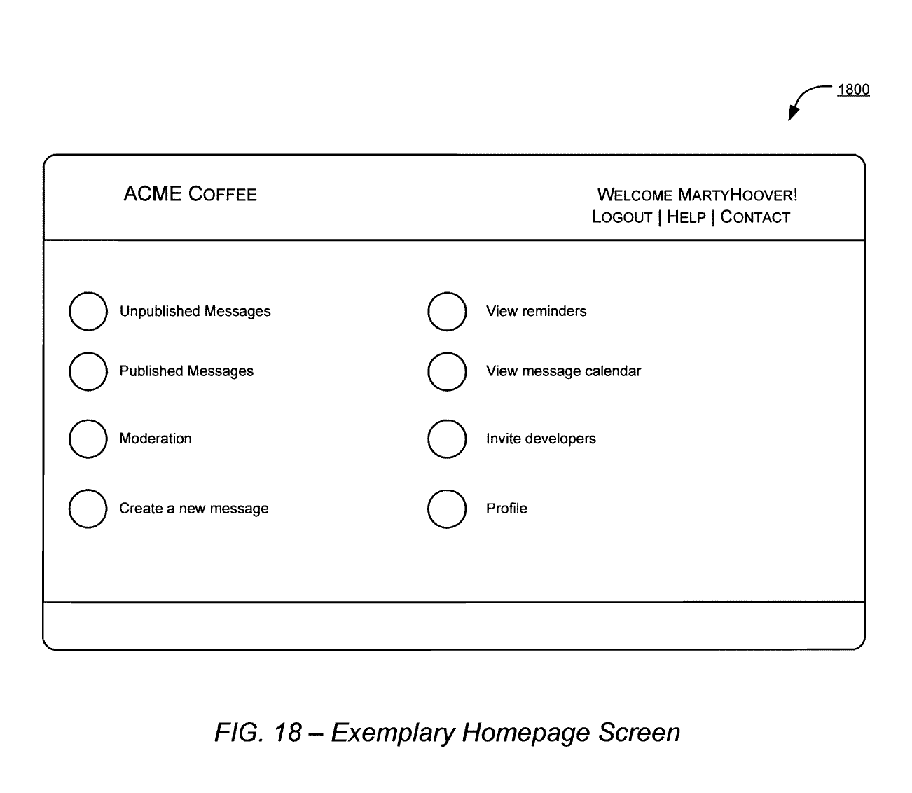

Once the desired marketing programs are added, a homepage greets the developer 114. FIG. 18 illustrates an exemplary SRM system homepage screen 1800. From here, the developer 114 may view multiple items such as published or unpublished messages, flagged responses, message calendars, reminders, tasks due, active marketing programs, or lists of associated developers. In addition, the developer 114 may perform actions such as create a message, change access rights, preview messages, modify unpublished messages, create graphs, and other such management specific actions. As will be understood and appreciated, the homepage 1800 acts as a starting point for managing messages and marketing programs for a client's social media system advertising.

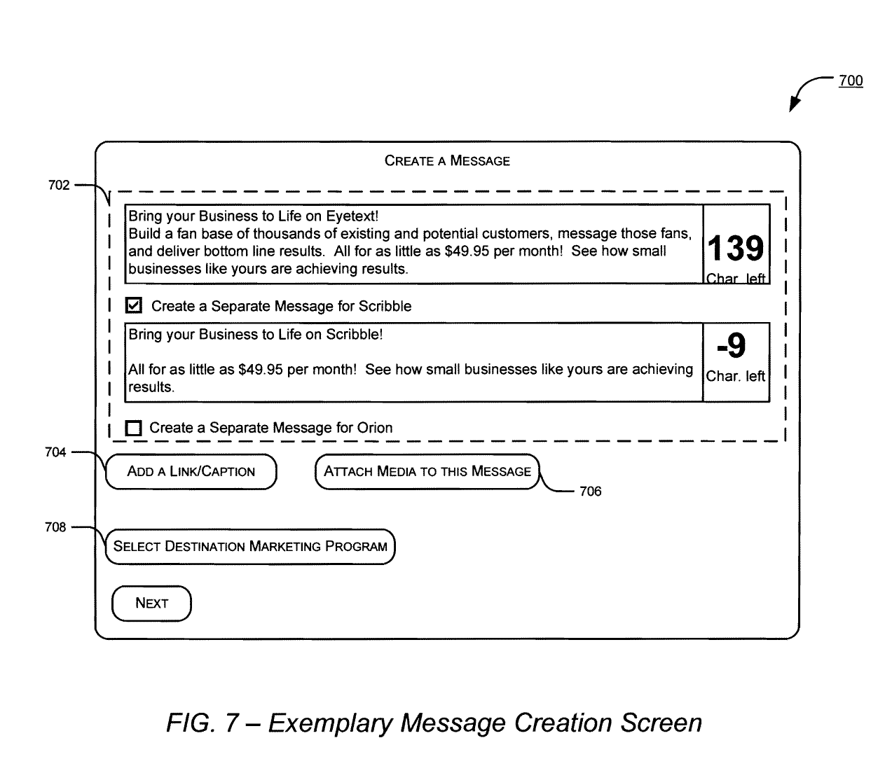

At step 404, the user (i.e., developer) creates a message for use in connection with one or more destination marketing programs 118 to be eventually displayed on one or more social media system portals to social media system members. To create the message, the developer 114 first logs-in to the user interface 201, and instructs the user interface 201 to display a message creation interface, or a message modification interface. The message creation interface may include drop down menus, service buttons, or may require the developer to type in a query or response. FIG. 7 illustrates an exemplary message creation interface screen. The developer 114 may enter text (block 702), embed a URL (radio button 704), or add media (radio button 706), such as images, video, audio, coupons, or forms. Further, the developer 114 may select destination marketing programs 118 from a list of active destination programs (radio button 708). In this way, a developer can select a message to be delivered in connection with a marketing program that spans many different social media outlets, all from a singular location. The interface 201 may also allow developers 114 to alter, modify, or enter new text depending on the destination social media system 110. If, for example, one social media system 110 is more informal that the others, developers 114 may alter the message content to create an informal message. Or, for example, if a given social media system has a character limit on the number of text characters that can be displayed in connection with any one message, the message creation interface 700 may display a “char left” indicator showing how many characters the message has left until it reaches its limit.

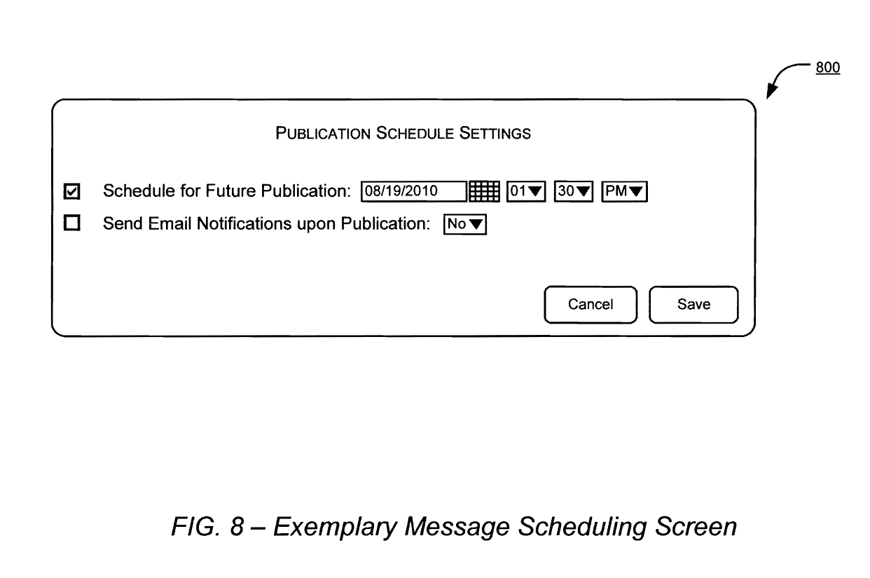

At step 406, the user schedules message delivery (e.g., screen shown in FIG. 8). The developer 114 may schedule delivery at a predetermined time or publish immediately. Moreover, the scheduler 204 may permit scheduling different delivery times for the destination marketing programs 118 or the destination social media systems 110. Alternatively, the scheduler 204 may permit developers 114 to configure one delivery time to publish the message on the social media systems. The scheduler 204 may also schedule repeated delivery of a message if desired.

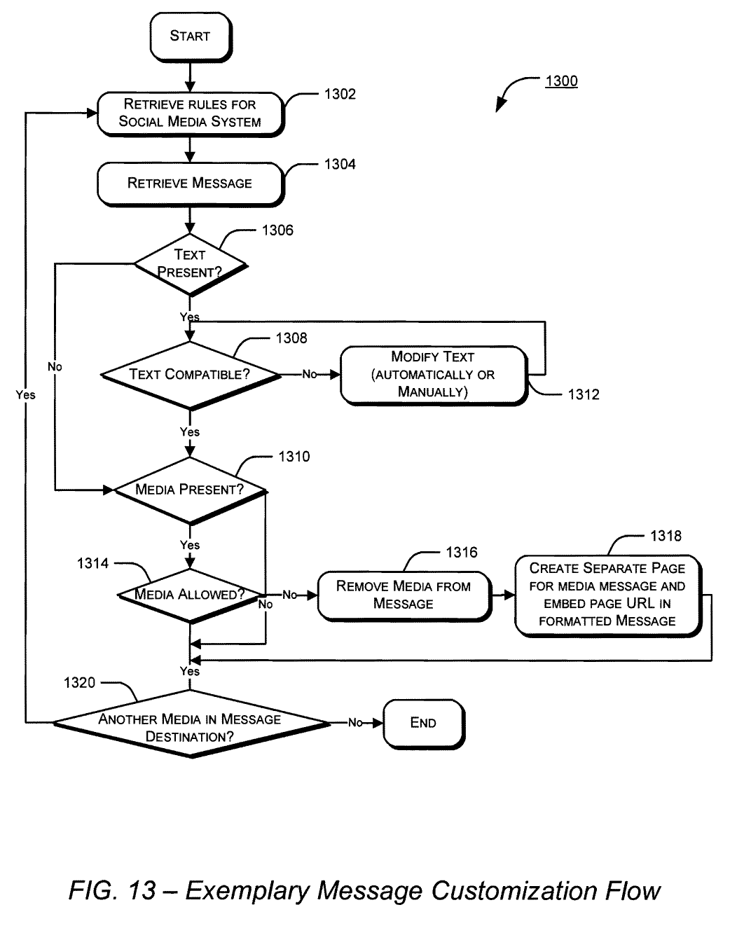

The method proceeds to step 408 where the formatter 206 customizes the message format according to predefined rules corresponding to the destination social media system 110. As described previously, social media system 110 messages may vary based on required standards, such as rules, policies, and formats. For example, such rules or policies include character limits on messages, content requirements, prohibitions on certain types of multimedia content, formatting issues, etc. In addition to these standards, different social media systems 110 may possess unique characteristics; for instance, users of some systems may be accustomed to communicate through short, witty, one-liners (e.g., Twitter®), while users of other systems may be comfortable with longer and fuller messages (e.g., Facebook®), and others may be familiar with formal or professional messages (e.g., Linked In®). In order to publish the most effective messages, in addition to the required standards, developers 114 may also be aware of these system specific nuances and characteristics. The formatter 206 aids developers 114 to publish the most appropriate message for a particular destination social media system 110, by prompting developers 114 to modify messages or by automatically editing messages according to configured rules. The formatter 206 may, for instance, prompt the developer 114 to change the message tone for a particular destination system 110. Alternatively, the formatter 206 may remove attached media from a message if the destination system 110 does not allow multimedia messages. Functionality of the formatter 206 will be described in detail with reference to FIG. 13.

At step 410, the customized message is published on the selected destination social media systems in connection with the corresponding marketing programs 118 at the scheduled time. The publisher 208 may utilize one or more publication techniques, such as interfacing with each social media systems' API to publish the message according to the social media system's protocols and requirements. Moreover, it will be understood that other message publication methods, known in the art, are not beyond the scope of the present disclosure.

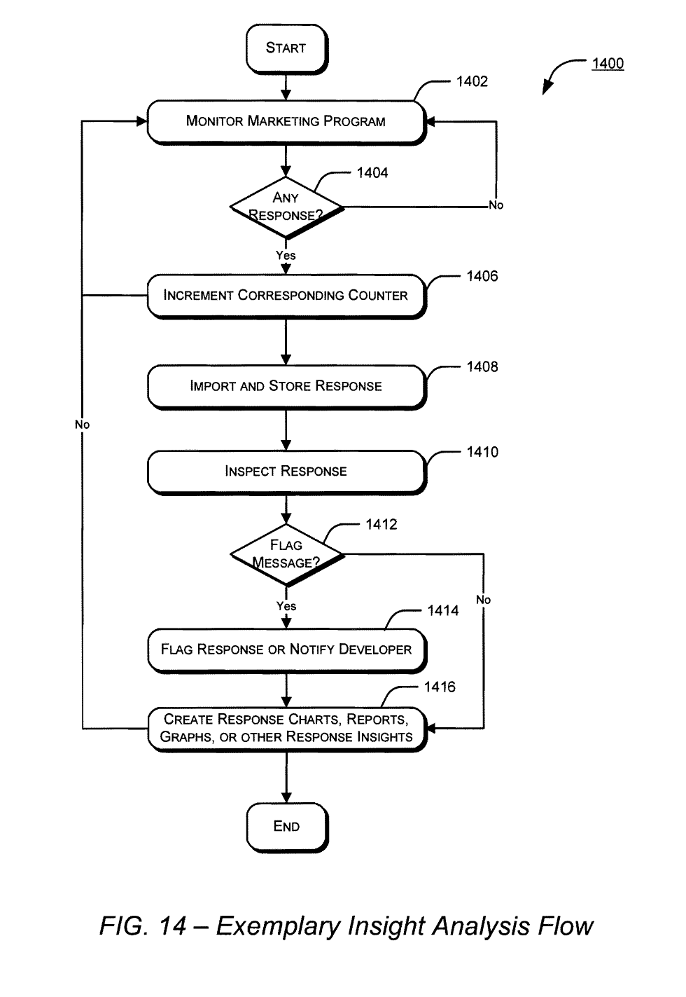

Finally, at step 412, the importer 214 may monitor the social media systems for responses to the published messages. The responses may be extracted and stored in the database 104 for analysis. FIG. 14 illustrates these monitoring, tracking, and analyzing functions of the SRM 101 in detail.

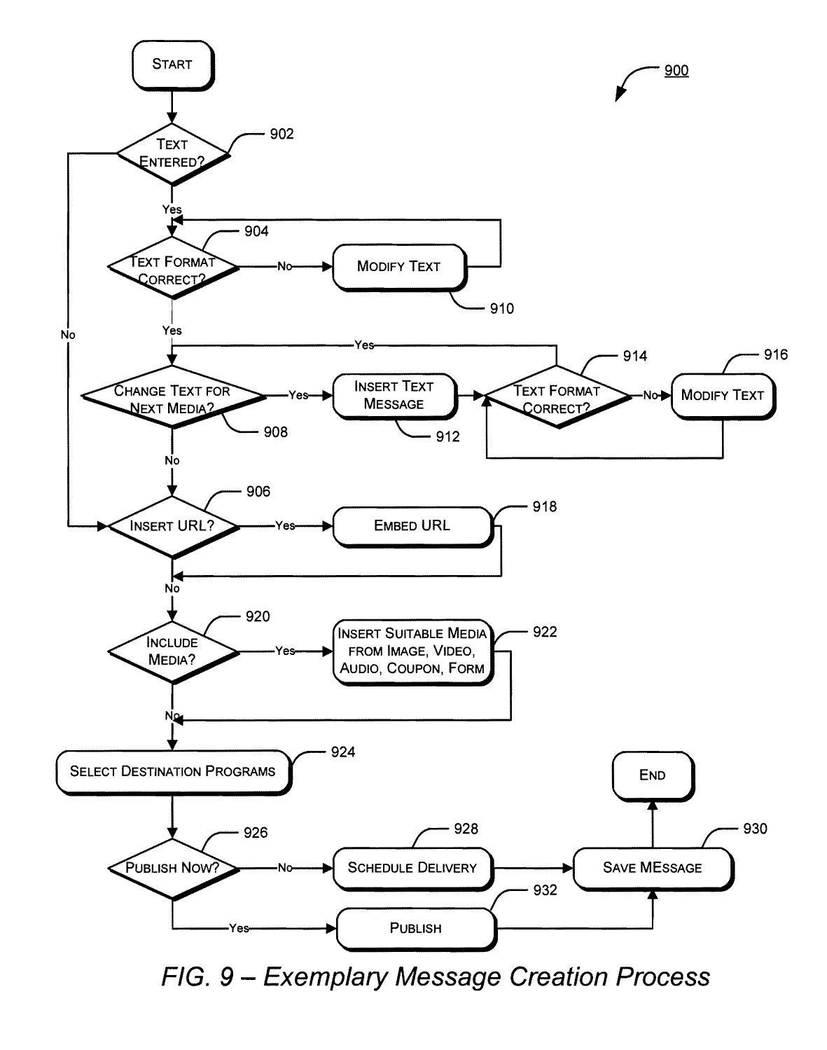

FIG. 9 illustrates an exemplary method 900 for creating a message, and FIGS. 7 and 10-12 illustrate exemplary message creation screens. At step 902, the input module 202 determines whether the developer 114 has inserted text. If yes, the method proceeds to step 904; else, the method proceeds to step 906. At step 904, while the developer is entering the text or at a later time (such as before publishing, before scheduling, or immediately after the developer has finished entering the text), the formatter 206 checks whether the message is compatible with the destination social media system's format requirements. If the text adheres to the desired text format, the method proceeds to step 908, else at step 910, the formatter 206 prompts the developer 114 to modify the text in accordance with the format, or automatically modifies the text message according to predefined rules.

The user interface 201 may have different text boxes for different social media systems 110 (as shown in FIG. 7). Alternatively, the user interface 201 may include dropdown menus or checkboxes for selecting the social media systems 110 for which the developer 114 wishes to modify the message. Here, when the social media system 110 is selected, the user interface 201 may open additional text boxes for message alteration. In some embodiments, the developer simply creates a single message for publication on various social media systems, and the SRM system formats the message according to predetermined specifications for each social media system requirements (i.e., the developer does not create separate messages for each social media system).

At step 908, if the developer 114 does not wish to modify the text message for other destination systems 110, the method proceeds to step 906. Alternatively, if the developer 114 wishes to modify the message for a particular social media system 110, the method 900 proceeds to step 912, where the user interface 201 prompts the developer 114 to insert/modify the text message (as shown in FIG. 7). Next, the formatter 206 checks the text format at step 914. If the format is not correct, the formatter 206 modifies the text at step 916; else, the method goes back to step 908, where the developer 114 may be prompted to include text for the next social media. This process continues until the developer 114 has created or modified messages for all desired social media systems 110.

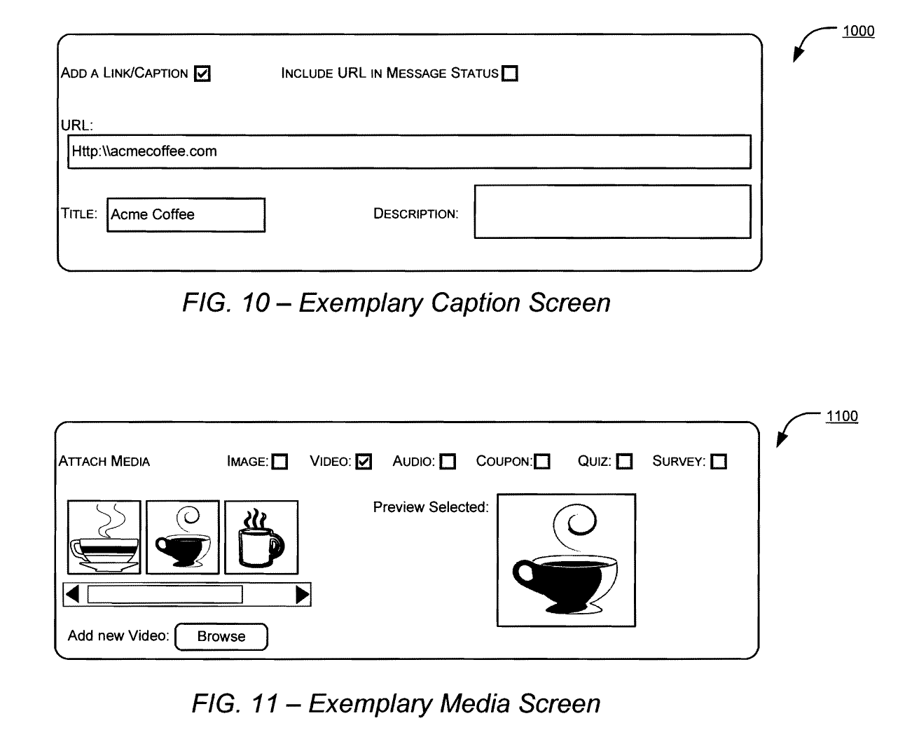

At step 906, the developer 114 determines whether to insert a URL. If yes, the developer 114 simply embeds the URL, at step 918, as depicted in FIG. 10. If not, the method proceeds to step 920, where the developer 114 decides to add media to the message. The user interface 201 permits the developer to select media from multiple media options including images, videos, audio, coupons, forms, banner advertisements, etc. (FIG. 11). The user may also add custom media types to this list if required. Further, a tab, an icon, a dropdown menu, or any other such graphical tool may represent the media options. On selecting a particular media option, the developer 114 may be presented with available media files in that category. Moreover, the developer 114 may be allowed to add new files to the selected media by browsing through files present on the developer's 114 system, server, external drive, or other such system, or by directly browsing through the Internet 108. Multiple files and multiple media type may be added to the message at step 922.

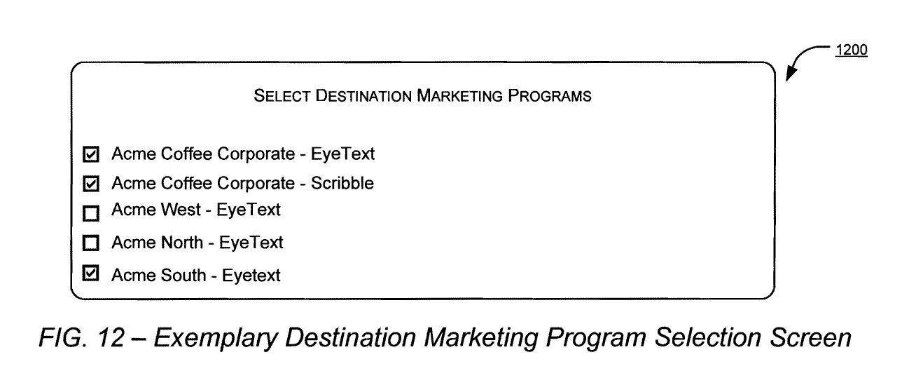

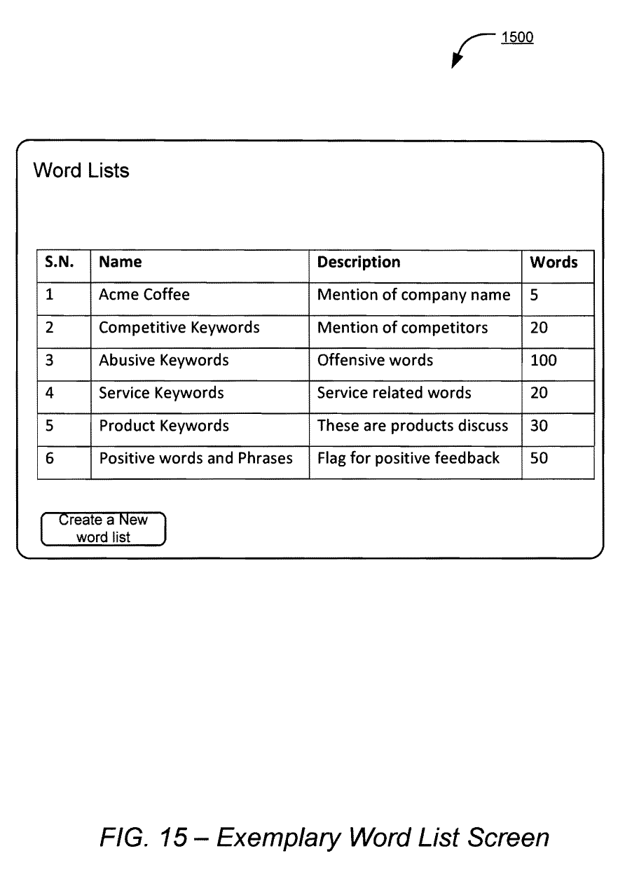

At step 924, the user/developer proceeds to select destination marketing programs 118. FIG. 12 illustrates an exemplary program selector screen 1200. As mentioned previously, marketing programs are high-level categorical delineations used to categorize and group a number of advertising messages associated with each program. Users 116 may select one or more active destination programs for publication. Next, the method proceeds to step 926 where the developer 114 selects between publishing instantaneously or at a scheduled time. If the developer decides to schedule delivery (step 928), the user interface 201 may allow the developer 114 to set schedule times for the marketing programs 118 individually. Alternatively, the scheduler 204 may allow the developer to select one scheduled time to deliver the message to all destination marketing programs 118 (as shown in FIG. 15). Once the message is scheduled, the message is saved at step 930. If the developer 114 wishes to schedule message delivery to individual destination programs, steps 928-932 are repeated for the selected marketing programs 118. If the developer 114, on the other hand, decides to publish instantly (yes path from step 926), the message is published (step 932) and saved (step 930).

FIG. 13 is a flowchart illustrating an exemplary method 1300 for customizing a message according to a destination social media system 110. The formatter 206 may be invoked at a number of times to customize or format the message. In some cases, the formatter 206 may be invoked at the same time the message creation/modification interface is activated. In this manner, the formatter 206 may alert the developer 114 while the text is being created, for example, the formatter 206 may count text characters and alert the developer 114 when the text characters exceed the limit for the specific social media system 110. In other cases, the formatter 206 may be invoked once the message is completed, or before publication. If a message includes a URL and exceeds the word limit by five characters; instead of deleting the last five characters of the URL, the formatter 206 may delete the end of the text just before the URL.

At step 1302, the formatter 206 retrieves rules and policies associated with the selected destination social media system 110. These rules may include format standards required by a particular system and flexible best practices. These factors may be updated at regular periods with advances in technology, social behaviors, and platforms. Moreover, developers 114 may set their own rules to improve messages. For example, a developer (or other client member) may utilize the formatter 206 to create a list of words or other content that are used to screen message tone and content before publishing.

At step 1304, the formatter 206 retrieves the message and subsequently checks if the message includes text at step 1306. If yes, the method proceeds to step 1308, where the formatter 206 determines whether the text is compatible with the defined text rules and standards; else, the method proceeds to step 1310.

At step 1312 (no path from step 1308), the formatter 206 either prompts the developer 114 to modify the text, or modifies the text automatically according to predetermined rules. Once, the text is compatible, the method proceeds to step 1310, where the formatter 206 checks whether the message is a multimedia message. If yes, the formatter 206 checks whether the selected social media system 110 permits multimedia messages at step 1314. In case the selected social media system 110 allows multimedia messages, the method proceeds to check whether another social media system 110 is selected for message delivery. If a certain social media system 110 does not allow multimedia messages, the formatter 206 removes media from the message and saves the message at step 1316. Next, at step 1318, the formatter 206 may create a separate page for the complete multimedia page and the page's URL may be added to the text message. In this manner, developers 114 may display multimedia messages on systems that do not permit multimedia messages. When a user 116 selects the embedded link on the destination system 110, the user 116 will be redirected to the complete multimedia message on a separate page. Users 116 may post comments and responses to the complete message from the redirected page directly.

At step 1320, if multiple destination systems are selected, the method returns to step 1302 and the process is completed for the next system 110, else the formatter 206 saves changes to the message and exits.

FIG. 14 is a flowchart illustrating an exemplary method 1400 for analyzing message insights according to some embodiments of the present invention. As described with relation to FIG. 2, the managing module 102 includes an importer 214 and moderator 212, which along with the controller 210 help analyze responses to published messages. Responses include replies, likes, shares, posts, messages, emails, clickthroughs to embedded URLs, etc. The SRM 101 analyzes these responses to improve their marketing strategies, as such responses indicate consumer interest in various products, relative success of types of marketing strategies or messages, and other helpful information.

The method begins at step 1402, where the importer monitors active marketing programs 118. The first step is a continuous step that loops continuously, unless the importer is instructed to stop monitoring. If the importer 214 detects any responses at step 1404, the corresponding response counter is incremented at step 1406.

Embedded URLs are shortened using the “Meta Refresh” technology that first brings the user 116 on the shortened URL webpage, and after a short or no interval, the webpage is refreshed and the user 116 is redirected to the original web page. This redirection through the shortened URL allows the importer 214 to track any click throughs. When a user 116 clicks on the shortened URL, the user 116 first lands on an SRM 101 generated URL, where the number of visits can be recorded. As will be understood and appreciated, embodiments of the present system are not limited solely to use of the known “Meta Refresh” technology to shorten URLs, and other such technologies and methods are used in various embodiments as will occur to one of ordinary skill in the art.

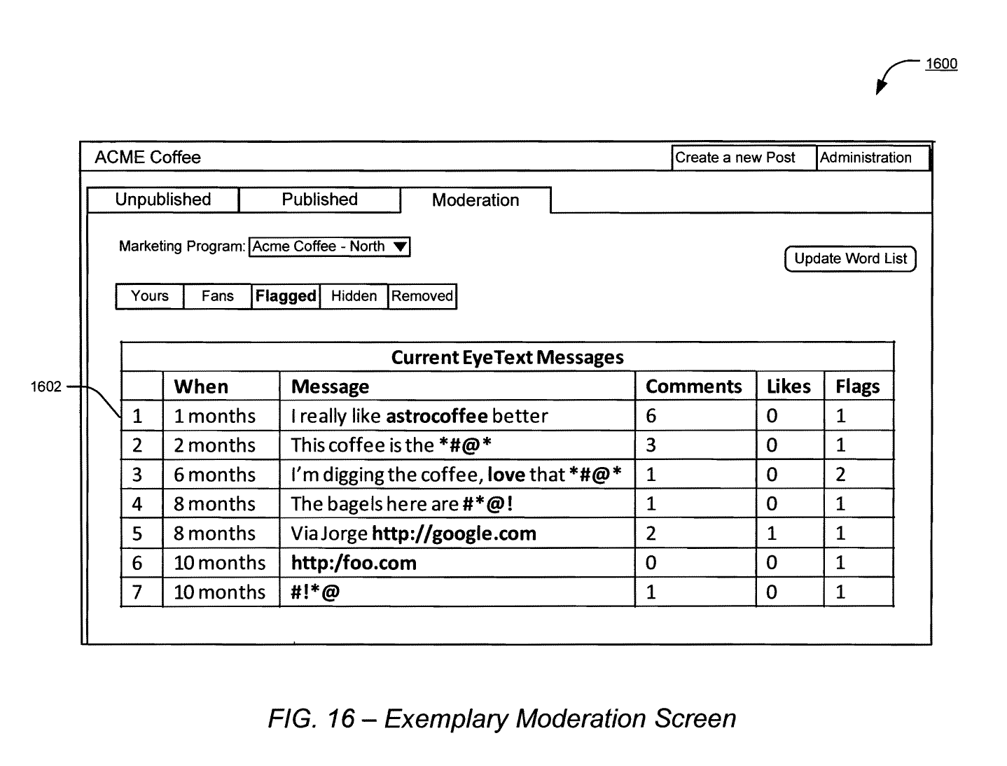

At step 1408, the importer 214 extracts any text responses from the marketing programs 118 and stores the responses in the database 104 for further analysis. Next, the moderator 212, at step 1410, inspects the stored responses. As described previously, the moderator 212 may incorporate multiple message screening word lists (e.g., screenshot FIG. 15), such as abusive language lists, competitor names lists, etc. At step 1412, in case the message text matches with any word in the screening word list, the message is flagged. Moreover, the moderator 212 may check messages for embedded URLs. The message is automatically flagged if the message includes any URLs. FIG. 16 illustrates an exemplary moderation screen 1600 depicting flagged messages.

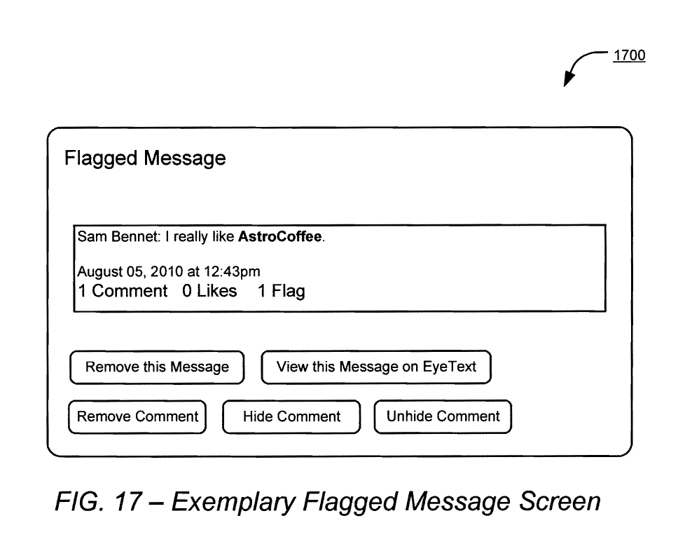

The moderator 212 may be programmed to take any suitable action against flagged messages at step 1414. For example, on selecting any flagged message, such as message 1602, a new screen (FIG. 17) opens that allows the developers 114 to delete the original message on the marketing campaign, notify the associated developers 114, store the message in the flagged repository, or a combination of these.

If no detrimental issues were uncovered during the moderation, the message is not flagged, but saved in the database 104 for further analysis at step 1416. Here, messages or response counter information from the marketing programs 118 may be collected to generate statistical reports, interactive charts, and drill-down graphs that depict the success or failure of a message to compel users 116 to respond.

Systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data. The claimed invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories. Storage devices suitable for tangibly embodying computer program instructions and data include forms of non-volatile memory, including by way of example, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

The foregoing description of the exemplary embodiments has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the systems and their practical application to enable others skilled in the art to utilize the systems and various embodiments and with various modifications as are suited to the particular use contemplated. Alternative embodiments will become apparent to those skilled in the art to which the present disclosure pertains without departing from their spirit and scope. Accordingly, the scope of the present inventions is defined by the appended claims rather than the foregoing description and the exemplary embodiments described therein.

What is claimed is:

1. A method for managing a plurality of marketing messages created by a marketer via a social relationship management system (SRMS) to be displayed to a plurality of members of one or more social media systems via portals associated with the one or more social media systems, comprising the steps of:
receiving message detail information at the SRMS from the marketer corresponding to a marketing message to be displayed via one or more social media systems (SMSs) to SMS members via SMS portals, the message detail information including one or more of: (a) one or more SMS identifiers indicating one or more social media systems for which the message is to be displayed, (b) date information corresponding to a display date for displaying the message on each SMS, and (c) message content;
identifying from the one or more SMS identifiers in the message detail information the one or more social media systems for which the message is to be displayed;
for each identified SMS for which the message is to be displayed, retrieving one or more predetermined rules from an SRMS database corresponding to one or more formatting requirements associated with the identified one or more social media systems;
formatting the message content associated with the marketing message at the SRMS according to the one or more predetermined rules; and
transmitting the formatted marketing message to the one or more SMSs for display to SMS members via the SMS portals on the display date, wherein the message is transmitted via an interface between the SRMS and each SMS.

2. The method of claim 1, wherein the message detail information further includes one or more of: a message identifier, time information corresponding to a specific time for displaying the message, a marketing program identifier corresponding to an associated marketing program to which the message relates, a developer identifier corresponding to a developer that generated the message, and a schedule for repeat displays of the message.

3. The method of claim 1, wherein the message content is selected from the group comprising: text, images, video files, sound files, custom files, SMS-specific files.

4. The method of claim 1, wherein the message detail information is generated by a content developer associated with the marketer via an Internet-accessible portal operatively coupled to the SRMS.

5. The method of claim 1, further comprising the step of storing the message detail information in the SRMS database.

6. The method of claim 1, wherein the one or more predetermined rules corresponding to the one or more formatting requirements associated with the identified one or more social media systems are selected form the group comprising: message character limits, prohibitions on multimedia content, limitations on multimedia content, text font requirements, text size requirements, embedded URL requirements, content file type requirements.

7. The method of claim 1, wherein the one or more predetermined rules further correspond to specific message requirements dictated by the marketer, the specific message requirements including one or more of access privileges for content developers, marketing program-specific standards, message display frequency, message content requirements.

8. The method of claim 1, further comprising the step of subsequent to formatting the message content, if the message content does not satisfy the one or more predetermined rules, prompting the marketer to modify the message content as a function of the one or more predetermined rules.

9. The method of claim 1, wherein the marketing message is associated with a marketing program initiated by the marketer.

10. The method of claim 9, wherein the marketing program corresponds to a specific product, group of products, locality, theme, or division of the marketer.

11. The method of claim 1, further comprising the step of providing an alert to the marketer prior to transmission of the formatted marketing message to the one or more SMSs, wherein the alert indicates that the message will subsequently be transmitted to the one or more SMSs.

12. The method of claim 11, wherein the alert is provided sufficiently in advance of transmission to enable the marketer to revise, update, or cancel the message prior to transmission.

13. The method of claim 1, further comprising the step of, prior to transmitting the formatted marketing message to the one or more SMSs, storing the formatted marketing message until the display date.

14. The method of claim 1, wherein the interface between the SRMS and each SMS is an application programming interface (API) that enables communication between the SRMS and each SMS.

15. The method of claim 1, further comprising the step of receiving response information at the SRMS from the one or more SMSs corresponding to member responses relating to member interaction with the marketing message.

16. The method of claim 15, wherein the response information includes one or more of the following: information corresponding to message views, information corresponding to message clicks, information corresponding to multimedia content views, information corresponding to URL clicks, information corresponding to comment posts, SMS-specific responses.

17. The method of claim 15, further comprising the step of generating performance metric information associated with the marketing message based on the response information.

18. The method of claim 15, further comprising the step of moderating the response information to identify response content that includes predetermined items.

19. The method of claim 18, wherein the predetermined items are selected from the group comprising: profane language, marketer competitor names, derogatory terms, prohibited members, predetermined words, website links.

20. A social relationship management system (SRMS) operatively connected to one or more social media systems to provide a plurality of marketing messages created by a marketer via the SRMS to members of the one or more social media systems via portals associated with the one or more social media systems, comprising:
an input module for receiving message detail information at the SRMS from the marketer corresponding to marketing messages to be displayed via one or more social media systems (SMSs) to SMS members via SMS portals, the message detail information including one or more of: (a) one or more SMS identifiers indicating one or more social media systems for which the messages are to be displayed, (b) date information corresponding to a display date for displaying each message on each SMS, and (c) message content;
a database for storing the message detail information corresponding to the marketing messages, as well as predetermined rules corresponding to one or more formatting requirements associated with the one or more social media systems for formatting marketing messages;
a formatting component for formatting the marketing message content associated with the marketing messages at the SRMS according to the one or more predetermined rules; and
a communication link between the SRMS and the one or more SMSs to provide operative communications between the SRMS and the one or more SMSs, the communication link configured to transmit the formatted marketing messages to the one or more SMSs for display to SMS members via the SMS portals on the respective display dates.

21. The system of claim 20, wherein the message detail information further includes one or more of: a message identifier, time information corresponding to a specific time for displaying each message, one or more marketing program identifiers corresponding to associated marketing programs to which the messages relate, one or more developer identifiers corresponding to developers that generated the messages, and a schedule for repeat displays of each message

22. The system of claim 20, wherein the message content is selected from the group comprising: text, images, video files, sound files, custom files, SMS-specific files.

23. The system of claim 20, wherein the message detail information is generated by one or more content developers associated with the marketer via an Internet-accessible portal operatively coupled to the SRMS.

24. The system of claim 20, wherein the one or more predetermined rules corresponding to the one or more formatting requirements associated with the one or more social media systems are selected form the group comprising: message character limits, prohibitions on multimedia content, limitations on multimedia content, text font requirements, text size requirements, embedded URL requirements, content file type requirements.

25. The system of claim 20, wherein the one or more predetermined rules further correspond to specific message requirements dictated by the marketer, the specific message requirements including one or more of access privileges for content developers, marketing program-specific standards, message display frequency, message content requirements.

26. The system of claim 20, wherein the formatting component performs the function of subsequent to formatting the message content, if the message content does not satisfy the one or more predetermined rules, prompting the marketer to modify the message content as a function of the one or more predetermined rules.

27. The system of claim 20, wherein each marketing message is associated with a marketing program initiated by the marketer.

28. The system of claim 27, wherein the marketing program corresponds to a specific product, group of products, locality, theme, or division of the marketer.

29. The system of claim 20, further comprising an notification component for providing an alert to the marketer prior to transmission of each formatted marketing messages to the one or more SMSs, wherein the alert indicates that the message will subsequently be transmitted to the one or more SMSs.

30. The system of claim 29, wherein the alert is provided sufficiently in advance of transmission to enable the marketer to revise, update, or cancel the message prior to transmission.

31. The system of claim 20, wherein the database stores the formatted marketing messages until their respective display dates.

32. The system of claim 20, wherein the communication link between the SRMS and each SMS includes an application programming interface (API) at each SMS that enables communication between the SRMS and each SMS.

33. The system of claim 20, further comprising an importer component for receiving response information at the SRMS from the one or more SMSs corresponding to member responses relating to member interaction with the marketing messages.

34. The system of claim 33, wherein the response information includes one or more of the following: information corresponding to message views, information corresponding to message clicks, information corresponding to multimedia content views, information corresponding to URL clicks, information corresponding to comment posts, SMS-specific responses.

35. The system of claim 33, wherein the importer component generates performance metric information associated with the marketing messages based on the response information.

36. The system of claim 33, further comprising a moderator component for moderating the response information to identify response content that includes predetermined items.

37. The system of claim 36, wherein the predetermined items are selected from the group comprising: profane language, marketer competitor names, derogatory terms, prohibited members, predetermined words, website links.

38. A computer-implemented method for managing one or more marketing programs on multiple social media systems, the method comprising:
creating a message for at least one marketing program;
scheduling delivery of the message to the marketing program;
customizing the message format according to the corresponding social media system; and
publishing the customized message on the marketing program at the scheduled time.

39. The computer-implemented method of claim 38, further comprising creating the one or more marketing programs.

40. The computer-implemented method of claim 38, wherein the message includes at least one of text, audio, video, image, or multimedia.

41. The computer-implemented method of claim 38, wherein the marketing program includes at least one of a product profile, an organizational profile, a personal profile, a group profile, or a community profile.

42. The computer-implemented method of claim 38, further comprising managing the marketing programs on multiple social networking systems from a single interface.

43. The computer-implemented method of claim 38, further comprising permitting collaboration between two or more developers to develop the message.

44. The computer-implemented method of claim 43, further comprising setting different access permissions for the developers.

45. The computer-implemented method of claim 43, further comprising alerting the developers on publication of messages.

46. The computer-implemented method of claim 38, further comprising scheduling repeated delivery of the message to the marketing program until a desired condition is met.

47. The computer-implemented method of claim 38, further comprising:
monitoring the marketing program; and
importing insights from the marketing program in response to the messages.

48. The computer-implemented method of claim 47, further comprising analyzing the insights.

49. The computer-implemented method of claim 38, further comprising moderating messages or response posts on the marketing program according to a defined quality standard.

50. A system for managing one or more marketing programs on multiple social media systems, the system comprising:
a user interface for:
accepting inputs from one or more developers to develop a message for at least one marketing program, and
displaying system outputs;
a scheduler for planning delivery of the message to the marketing program;
a formatter for customizing the message format according to the corresponding social media system;
a publisher for publishing the message on the marketing program at the scheduled time; and
a database for storing information regarding the one or more marketing programs.

51. The system of claim 50, wherein the user interface allows developers to develop a message including at least one of text, audio, video, image, or multimedia.

52. The system of claim 50, wherein the user interface allows developers to create at least one of a product profile, an organizational profile, a personal profile, a group profile, or a community profile.

53. The system of claim 50, further comprising a controller for allowing collaboration between two or more developers to develop the message.

54. The system of claim 53, wherein the controller assigns access permissions for the developers.

55. The system of claim 53, wherein the scheduler alerts the developers on publication of messages.

56. The system of claim 50, wherein the scheduler schedules repeated delivery of the message to the marketing program until a desired condition is met.

57. The system of claim 50, further comprising an importer for:
monitoring the marketing program; and
importing insights from the marketing program in response to the messages.

58. The system of claim 57, wherein the importer further analyzes the insights.

59. The system of claim 50, further comprising a moderator for maintaining the quality of the message or response posts on the marketing program according to a defined quality standard.
